(19) United States
(12) Patent Application Publication
(10) Pub. No.: US 2008/0068165 A1
(43) Pub. Date: Mar. 20, 2008

(54) RADIO FREQUENCY IDENTIFICATION NUMBERING FOR CORRECT DIRECTION INDICATION

(76) Inventors: Jimmie Earl DeWitt, Georgetown, TX (US); Riaz Y. Hussain, Austin, TX (US); Frank Eliot Levine, Austin, TX (US); Enio Manuel Pineda, Austin, TX (US)

Correspondence Address: IBM CORP (YA);C/O YEE & ASSOCIATES PC, P.O. BOX 802333, DALLAS, TX, 75380, US

(21) Appl. No.: 11/531,168

(22) Filed: Sep. 12, 2006

(51) Int. Cl. G08B 13/14; B60Q 1/00; G08G 1/123

(52) U.S. Cl. 340/572.1; 340/438; 340/988

(57) ABSTRACT

A computer implemented method, apparatus, and computer usable program code for determining a proper direction of travel of a vehicle. A first value is received from a first radio frequency identification tag by the vehicle. A second value is received from a second radio frequency identification tag by the vehicle. A first value and a second value associated with the radio frequency identification tags are identified. A determination is made whether the second value is in an ordinal sequence with the first value to denote the proper direction of travel. In response to a determination that the second value is not in sequence with the first value, a signal is sent that the direction of travel of the vehicle is contrary to the proper direction of travel.

### BACKGROUND OF THE INVENTION

1. Field of the Invention

The present invention relates generally to an improved data processing system and in particular, to a data processing system located within a vehicle. Still more particularly, the present invention relates to a computer implemented method and apparatus for presenting a direction indication to a driver in a vehicle.

2. Description of the Related Art

The use of computers has become more and more pervasive in society. This pervasiveness includes the integration of personal computers into vehicles. The utilization of computer technology is employed to provide users or drivers with a familiar environment. In this manner, a user's ability to easily use computing resources in an automobile is provided. In addition, it is envisioned that car buyers would be able to use most of the same software elements in an automobile that are used at home or in the office. Further, an automobile owner could completely customize driver information displays to create an optimal environment for the driver's needs. Various platforms have been developed and are being developed for use in automobiles and other vehicles. Many platforms provide the computing strength of a personal computer platform with widely recognized as well as emerging technologies. Widely accepted technologies that may be implemented within an automobile include cellular/global system for mobile communications (GSM), global positioning system (GPS), and radio data broadcast (RDB). These devices allow a driver to navigate, receive real-time traffic information and weather forecasts, access databases of personalized information, and place and receive telephone calls, as well as send and receive email and faxes from an automobile.

Another key feature for adapting computer technologies for use in an automobile is a voice recognition user interface for the driver along with a more conventional graphical user interface (GUI) for passengers. Voice recognition technology is already well developed in multi-media desktop personal computers. For example, VoiceType family products available from International Business Machines Corporation may also be used in the automobile. Voice recognition technology allows drivers to easily control and interact with onboard computers and telephone applications, including productivity software, internet browsers, and other applications while allowing the driver to keep their hands on the wheel and their eyes on the road. Such productivity is especially important when some surveys show that up to twelve percent of a person's waking life is spent in an automobile.

With all of this emerging technology, however, a problem still exists with drivers driving on the wrong side of the road against normal traffic flow. Drivers that are confused, impaired, or otherwise disoriented may inadvertently enter on-ramps, highways, freeways, and other roads from the wrong direction or end up driving on the wrong side of the road. Driving on the wrong side of the road is becoming more and more common with heavy construction and increasingly complex roadways. In some cases, the driver may be unaware of the danger of the situation until it is too late.

Existing systems, such as global positioning systems and on-board navigation systems may be incapable or unequipped to effectively alert the driver in order to avoid a serious collision, accident, citation, or general embarrassment. For example, global positioning systems cannot operate in environments such as tunnels and are subject to satellite signals being blocked due to high-rise buildings.

### SUMMARY OF THE INVENTION

The illustrative embodiments provide a computer implemented method, apparatus, and computer usable program code for determining a proper direction of travel of a vehicle. A first value is received from a first radio frequency identification tag by the vehicle. A second value is received from a second radio frequency identification tag by the vehicle. A first value and a second value associated with the radio frequency identification tags are identified. A determination is made whether the second value is in an ordinal sequence with the first value to denote the proper direction of travel. In response to a determination that the second value is not in sequence with the first value, a signal is sent that the direction of travel of the vehicle is contrary to the proper direction of travel.

### BRIEF DESCRIPTION OF THE DRAWINGS

The novel features believed characteristic of the illustrative embodiments are set forth in the appended claims. The illustrative embodiments, themselves, however, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a data processing system in which the illustrative embodiments may be implemented;

FIG. 2 is a block diagram of a data processing system in which the illustrative embodiments may be implemented;

FIG. 3 is a direction indication system in accordance with the illustrative embodiments;

FIG. 4 is a block diagram of an automotive computing platform in accordance with the illustrative embodiments;

FIG. 5 is a flowchart for a process for indicating direction based on radio frequency identification tags in accordance with the illustrative embodiments; and

FIG. 6 is a flowchart for an alternative process for indicating direction based on radio frequency identification tags in accordance with the illustrative embodiments.

### DETAILED DESCRIPTION OF THE PREFERRED EMBODIMENT

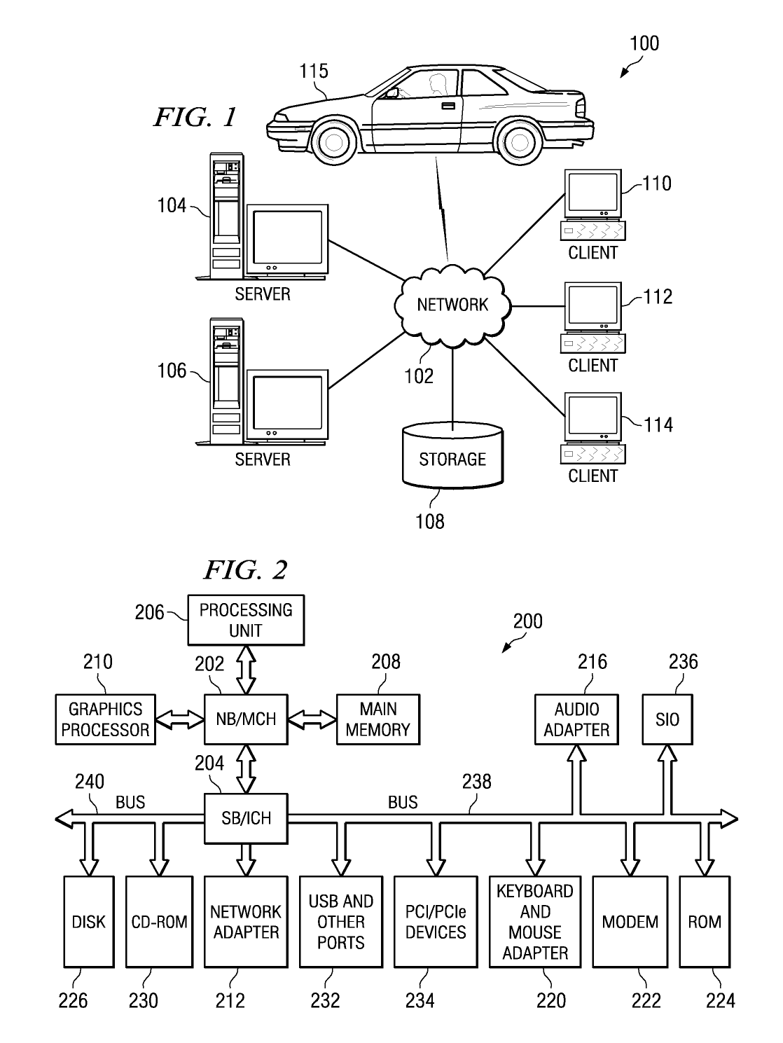

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

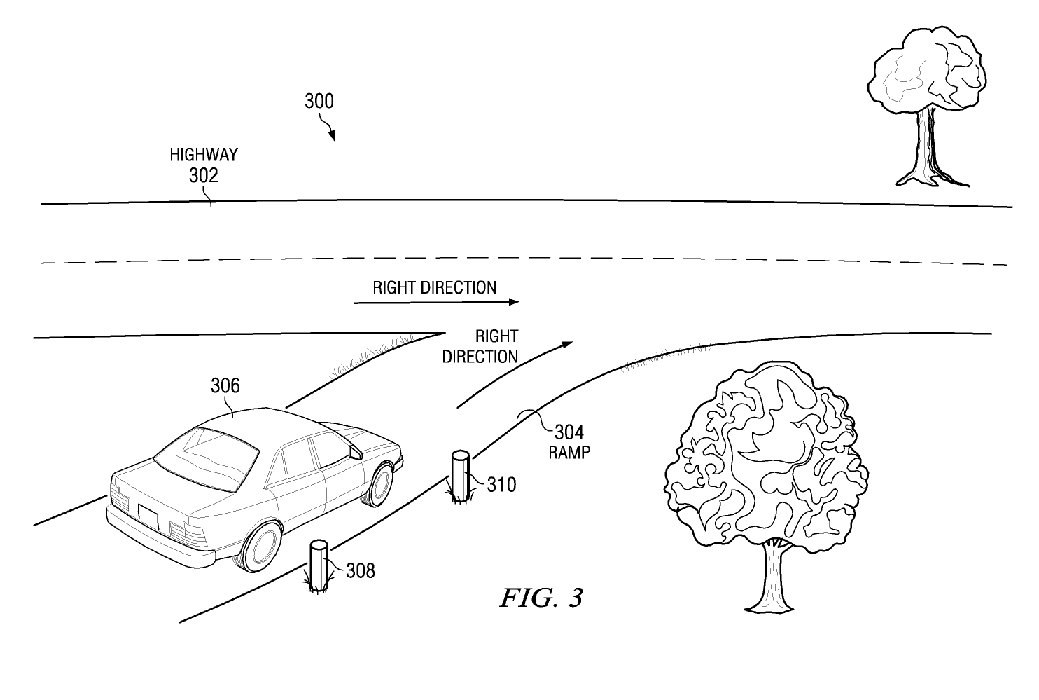

In the depicted example, server 104 and server 106 connect to network 102 along with storage unit 108. In addition, clients 110, 112, and 114 connect to network 102. These clients 110, 112, and 114 may be, for example, personal computers or network computers. Clients 110, 112, and 114 and servers 104, 106 may be devices such as vehicles, traffic signs, traffic control devices, and other electronically linked roadway devices. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown. Network data processing system 100 includes vehicle 115. Vehicle 115 communicates with network 102 using a wireless connection or other wireless communication link which may include a wireless transmitter and receiver for sending data and other electronic information. Vehicle 115 is further described in FIG. 3.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA. Data processing system 200 may be implemented in vehicles which may include automobiles, trucks, motorcycles, sports utility vehicles, boats, trains, or planes. Data processing system 200 may be internally integrated or externally integrated into the vehicle.

The illustrative embodiments provide a computer implemented method, apparatus, and computer usable program code for indicating a vehicle is traveling in the correct direction. Radio frequency identification (RFID) tags are embedded in a highway. A radio frequency identification tag reader on a vehicle receives information from the radio frequency identification tags as the vehicle passes over the radio frequency identification tags. The radio frequency identification tags include an associated number to indicate whether the vehicle is traveling in the correct direction.

For example, if the vehicle is traveling in the correct direction, the tag numbers will increment. If the tag numbers decrease, the vehicle is not traveling in the correct direction and an alarm is activated. The alarm is an audio, visual, or tactile alert that informs the driver that the vehicle is traveling in the incorrect direction or in the incorrect lane of traffic.

Turning next to FIG. 3, a direction indication system is depicted in accordance with the illustrative embodiments. Direction indication system 300 includes various elements used to indicate the direction or verify the proper direction of travel. Highway 302 is a road or roadway for any form of transport. Highway 302 is also representative of roads, freeways, or other physical transportation mediums. In other illustrative embodiments, highway 302 may be a waterway, railroad tracks, bike path, tunnel, runway, or other transportation or shipping pathway. The indicated direction of travel along the roadway is established by laws, norms, signs, or other rules and conventions followed or established by the people in a specified geographic region. For example, in the United States, the law establishes that vehicles travel on the right side of the road, and England has established that vehicles travel on the left side of the road.

Highway 302 includes ramp 304. Ramp 304 is a connecting road to highway 302. Ramp 304 may be an on-ramp, frontage road or feeder road, one-way street, intersection, or other roadway for allowing traffic to enter highway 302. Vehicle 306 is a conveyance by which a person or property is or may be transported upon the highway, water, or airways. The most common types of vehicles on highway 302 may include passenger vehicles, motorcycles, busses, motor homes, bicycles, and trucks.

Radio frequency identification tags 308 and 310 are embedded in ramp 304. In one illustrative embodiment, radio frequency identification tags 308 and 310 are embedded in the middle of ramp 304 or a lane within ramp 304 so that traffic, including vehicle 306, predictably passes over radio frequency identification tags 308 and 310 before fully entering highway 302. Radio frequency identification tags 308 and 310 may also be part of lane indicators, paint, speed bumps, guard rails, curbs, reflector poles or other roadway elements. In another illustrative embodiment, radio frequency identification tags 308 and 310 may be embedded within highway 302.

Radio frequency identification tags 308 and 310 may be referred to as a set of radio frequency identification tags. A set of radio frequency identification tags is one or more radio frequency identification tags within a specified proximity. Radio frequency identification tags 308 and 310 are automatic devices that transmit a predetermined message in response to a predefined signal received from a radio frequency identification tag reader that is part of vehicle 306. The radio frequency identification tag reader receives or reads the radio frequency identification tags 308 and 310 when sufficiently close to vehicle 306.

Alternatively, radio frequency identification tags 308 and 310 may transmit a signal that is received by the radio frequency identification tag reader of vehicle 306 periodically. For example, radio frequency identification tags 308 and 310 may use radar or motion detection to transmit a signal to a reader of vehicle 306. Radio frequency identification tags 308 and 310 may also be pressure sensitive to send a predetermined signal based on the weight or presence of vehicle 306. Radio frequency identification tags 308 and 310 may also use sound detection to transmit a signal to the reader of vehicle 306.

In these depicted examples, radio frequency identification tags 308 and 310 may be passive radio frequency identification tags that receive, amplify, and retransmit signals on different frequencies back to vehicle 306. Passive radio frequency identification tags may include a minute antenna, integrated circuit, and memory. For example, the minute electrical current induced in an antenna of radio frequency identification tag 308 and 310 by the incoming radio frequency signal provides enough power for a CMOS integrated circuit (IC) in the tag to power up and transmit a response.

Radio frequency identification tags 308 and 310 may store predefined information. In these examples, radio frequency identification tags 308 and 310 store a number, value, identifier, and other additional data or information. For example, radio frequency identification tags 308 and 310 may store information regarding exact geographic location, internal tracking information, logistical information, and other useful data or information. Radio frequency identification tags 308 and 310 are preferably spaced closely with the values associated with each radio frequency identification tag storing a sequence value pair such as 1, 2, 3; 349, 350, 351; a, b, c; or other similar incrementing data, value, character, number, or information scheme. The values may be stored in an ordinal sequence for efficiently determining whether the direction traveled is correct. An ordinal sequence is a classification of data groups which are arranged according to an underlying continuum.

Radio frequency identification tags 308 and 310 may also store the specified sequence and the sequence values in a known bit position. Incrementing sequence values stored in radio frequency identification tags 308 and 310 as bits may indicate vehicle 306 is traveling in the proper direction. For example, incrementing bits 11 and 12 may be sequence values indicating travel in the correct direction stored in radio frequency identification tags 308 and 310. Radio frequency identification tags 308 and 310 may be 128 bit tags with bits 0 to 127.

Vehicle 306 may determine whether it is traveling in the correct direction based on the values stored in radio frequency identification tags 308 and 310. For example, when vehicle 306 passes over radio frequency identification tag 308, radio frequency identification tag 308 is read by the radio frequency identification reader of vehicle 306. The radio frequency identification tag reader may receive the value “1” from radio frequency identification tag 308 as a predetermined message. Subsequently, when vehicle 306 passes over radio frequency identification tag 310, the value “2” may be read by the radio frequency identification tag reader of vehicle 306.

The incrementing values stored in radio frequency identification tags 308 and 310 are used to indicate that vehicle 306 is traveling in the correct direction. If, however, vehicle 306 is traveling in the incorrect direction, decrementing values read from radio frequency identification tags 308 and 310 indicate vehicle 306 is traveling in the incorrect direction.

The information read from radio frequency identification tags 308 and 310 may be used by the computer system, navigation system or other logic components of vehicle 306 to provide the driver with an audio, visual, tactile, or other alert that vehicle 306 is traveling in the incorrect direction. The computer system of vehicle 306 may also communicate an alert to oncoming traffic, pedestrians, police/emergency personnel, road signals or other components or persons that may be in danger, or provide information to others.

In other examples, sets of associated radio frequency identification tags with ordinal sequential values, such as radio frequency identification tags 308 and 310 may be embedded in each lane of ramp 304 ensuring that vehicle 306 reads the values stored in radio frequency identification tags 308 and 310 regardless of physical position on ramp 304. In another example, radio frequency identification tags 308 and 310 may be installed at natural choke points or narrowing points, such as bridges ensuring that vehicle 306 passes over them. The illustrative embodiments are particularly useful in parking garages, tunnels, underpasses, or other underground or covered facilities where global positioning system, navigation systems, and other radio frequency devices may be inoperative or ineffective for determining direction. The illustrative embodiments are also effective for areas where road signs are limited or nonexistent.

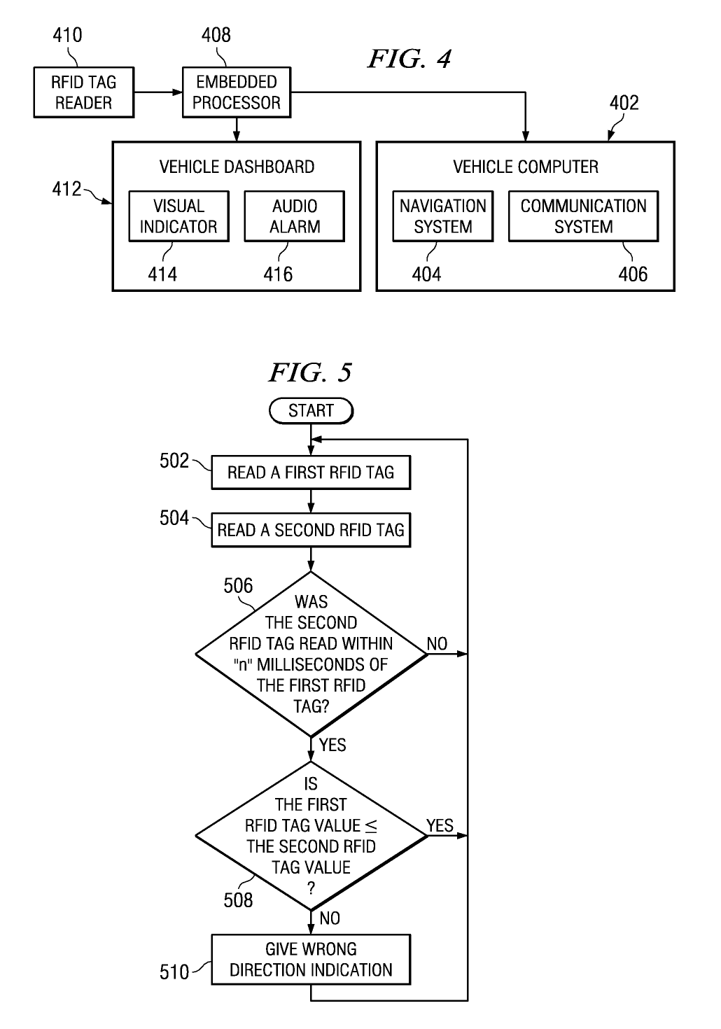

With reference next to FIG. 4, a block diagram of an automotive computing platform is depicted in accordance with the illustrative embodiments. Automotive computing platform 400 is the data processing system of a vehicle, such as vehicle 306 of FIG. 3. Automotive computing platform 400 may be implemented in a device, such as client 110 of FIG. 1 and may be configured similar to data processing system 200 of FIG. 2.

Automotive computing platform 400 includes various hardware components which may include vehicle computer 402, navigation system 404, communication system 406, embedded processor 408, radio frequency identification tag reader 410, vehicle dashboard 412, visual indicator 414, and audio alarm 416. In exemplary automotive computing platform 400, vehicle computer 402 includes navigation system 404 and communication system 406. Vehicle computer 402 receives information from the different systems and mechanisms of the vehicle in order to control vehicle functions.

Navigation system 404 provides navigational information to vehicle computer 402 which may be displayed to the driver. In these examples, navigation system 404 may be a global positioning system including an antenna and global positioning system receiver. Navigation system 404 allows the user to interactively enter and receive geographic information. Communication system 406 includes communication components for communicating with other users or devices. Communication system 406 may communicate with other devices, such as server 104, clients 112 and 114 through network 102 all of FIG. 1. For example, communication system 406 may use a wireless signal to communicate with other drivers, signs, cell phones, or other communication enabled devices.

Embedded processor 408 processes information and data for vehicle computers. Radio frequency identification tag reader 410 reads radio frequency identification tags, such as radio frequency identification tags 308 and 310 of FIG. 3. In one embodiment, radio frequency identification tag reader 410 is positioned on the bottom of the vehicle in order to increase the efficiency of transmitting a signal and receiving the radio frequency identification tag information. Radio frequency identification tag reader 410 may function to read values and information within a near proximity of the vehicle to effectively determine direction. Information from radio frequency identification tag reader 410 may be used by radio frequency identification tag reader 410 to determine if the vehicle is going in the proper direction.

Alternatively, the information from radio frequency identification tag reader 410 is processed by embedded processor 408 to determine if the vehicle is going in the proper direction. Embedded processor 408 may use values identified from the radio frequency identification tags to determine whether the vehicle is traveling in the correct direction. For example, if the values follow an ordinal sequence, everything functions as normal. If however, the values do not follow an ordinal sequence, embedded processor 408 may send input to visual indicator 414 or audio alarm 416 or both.

The direction information or values extracted from radio frequency identification tags may also be passed to communication system 406. Communication system 406 may send a message to individuals or objects that the vehicle is traveling in the wrong direction. For example, communication system 406 may send a message to a road signal, warning oncoming drivers that there is a vehicle traveling in the wrong direction. In another example, a message from communication system 406 may be passed to an automated system for alerting all pedestrians with cell phones and communication-enabled vehicles in the path of the oncoming vehicle.

If the vehicle is not going in the proper direction, an alert or alarm may be displayed to the driver in vehicle dashboard 412. In these examples, vehicle dashboard 412 may include visual indicator 414 and audio alarm 416. Visual indicator 414 is a visual alert that the vehicle is traveling in the wrong direction. For example, text, a wrong direction indicator, or a visual warning message may be displayed to the user. The visual alert may be displayed or flashed to vehicle instruments, warning lights, seat vibrator, or heads-up displays. In one illustrative embodiment, all of the lights in the vehicle may begin to flash to attract the attention of the driver. Additionally, the tail light flashers, visible from the dashboard, and head lights may be caused to blink.

Audio alarm 416 is an audio alert that the vehicle is traveling in the wrong direction. For example, audio alarm 416 may have an audio portion of navigation system 404 repeat “You are traveling in the wrong direction down the road”. The audio alarm may also be a whistle, beep, ping, or other sound to attract the attention of the driver. Audio alarm 416 may also sound the horn of the vehicle to warn other drivers.

In other embodiments, different alerts, indicators or alarm systems may be used. For example, the driver's seat or steering wheel may vibrate to indicate the vehicle is traveling in the wrong direction. In another example, vehicle computer 402 may establish a maximum speed of twenty miles per hour. Vehicle computer 402 may also activate the braking system to decelerate the vehicle based on the location of the vehicle, such as when the vehicle is entering a ramp or major highway in the wrong direction. In another embodiment, the radio frequency identification tags may also be used in conjunction with navigation system 404 to indicate known distances from specified geographic locations.

Turning next to FIG. 5, a flowchart for a process for indicating direction based on radio frequency identification tags is depicted in accordance with the illustrative embodiments. The process of FIG. 5 may be implemented by components of automotive computing platform 400 or embedded processor 408 of FIG. 4 in vehicle 306 of FIG. 3. In another embodiment, the process of FIG. 5 may be performed entirely by radio frequency identification tag reader 410 of FIG. 4.

The process begins by reading a first radio frequency identification tag (step 502). The first tag may be a tag, such as radio frequency identification tags 308 and 310 of FIG. 3. Next, the process reads a second radio frequency identification tag (step 504). The radio frequency identification tags are preferably embedded in sets in a roadway, such as highway 302 of FIG. 3.

Next, the process determines whether the second radio frequency identification tag was read within “n” milliseconds of the first radio frequency identification tag (step 506). Step 506 may be performed by embedded processor 408 of FIG. 4, based on information extracted from radio frequency identification tags by radio frequency identification tag reader 410 of FIG. 4. In these illustrative examples, “n” milliseconds is a specified timeout period to read the second radio frequency identification tag. If the second radio frequency identification tag is not read in the “n” milliseconds, there is a timeout. A timeout indicates that there is insufficient information to determine whether the vehicle is traveling in the wrong direction. For example, the driver may have pulled off of the side of the road between the two radio frequency identification tags for an emergency, and as a result, the first radio frequency identification tag was read but the second radio frequency identification tag was not. If the process determines that the second radio frequency identification tag was not read within the specified “n” milliseconds, the process reads a first radio frequency identification tag (step 502).

If the process determines the second radio frequency identification tag was read within “n” milliseconds of the first radio frequency identification tag, the process determines whether the first radio frequency identification tag value was less than or equal to the second radio frequency identification tag value (step 508). Step 508 may also be performed by embedded processor 408 of FIG. 4, based on information extracted from radio frequency identification tags by radio frequency identification tag reader 410 of FIG. 4. In this example, a vehicle is traveling in the correct direction if the first radio frequency identification tag value, such as radio frequency identification tag 308 of FIG. 3, is less than the second radio frequency identification tag value, such as radio frequency identification tag 310 of FIG. 3. In other words, if the values of the radio frequency identification tags are incrementing, the vehicle is traveling in the correct direction.

If the first radio frequency identification tag value was greater than the second radio frequency identification tag value, the process gives a wrong direction indication (step 510). The wrong direction indication may be signaled or otherwise presented to the driver by visual indicator 414 or audio alarm 416 both of FIG. 4.

Next, the process returns again to step 502. If the first radio frequency identification tag value was less than or equal to the second radio frequency identification tag value, the process returns again to step 502 without an alarm condition as the vehicle was traveling in the proper direction. The process of FIG. 5 is repeated continuously for the safety of the driver and the safety of others. As a result, drivers are able to quickly realize that the vehicle is incorrect in order to avoid accidents, damage to property, and injuries.

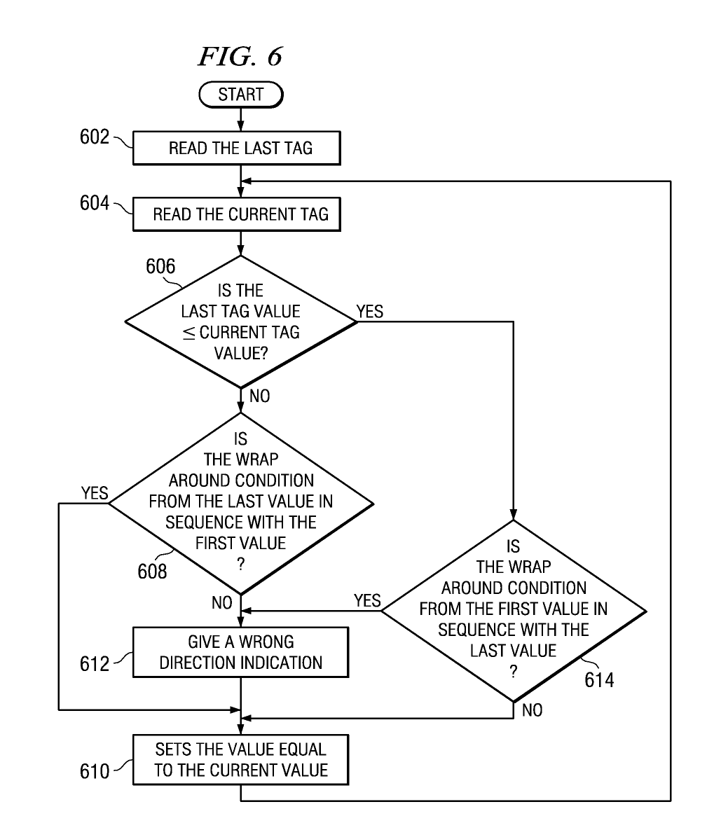

With reference to FIG. 6, a flowchart for an alternative process for indicating direction based on radio frequency identification tags is depicted in accordance with the illustrative embodiments. The process of FIG. 6 may be implemented by components of automotive computing platform 400 or embedded processor 408 of FIG. 4 in vehicle 306 of FIG. 3. In another embodiment, the process of FIG. 6 may be performed entirely by radio frequency identification tag reader 410 of FIG. 4.

In one illustrative embodiment, the radio frequency identification tags may be embedded in a reoccurring sequence. The reoccurring sequence does not require that the values of the radio frequency identification tag only increase but instead may follow the predefined sequence. For example, the information or values of the radio frequency identification tags may be encoded as two bits that are stored in the radio frequency identification tag in which the numbers follow the sequence 0, 1, 2, 3, 0, . . . The transition from 3 to 0 is not monotonically increasing and is treated as a special case when traveling in the correct direction. Conversely, the transition from 0 to 3 is taken as a special case when traveling in the wrong direction.

The process begins by reading the last tag (step 602). For example, the last tag may be the value “0” stored in radio frequency identification tag 310 of FIG. 3. Next, the process reads the current tag (step 604). For example, the current tag may be the value “3” stored in radio frequency identification tag 308 of FIG. 3. Next, the process determines whether the last tag value is less than or equal to the current tag value (step 606).

If the last tag value is greater than the current tag value, the process determines whether the wrap around condition from the last value is in sequence with the first value (step 608). The last identification is in sequence if the last value and the current value follows the predefined sequence even if the current value is greater than the last value. For example, a vehicle is still traveling in the correct direction if the last value was “3” and the current value is “0” where the sequence is 0, 1, 2, 3, 0, . . . If the wrap around condition from the last value is in sequence with the first value, the process sets the last value equal to the current value (step 610). Next, the process reads the current tag (step 604).

If the wrap around condition from the last value is not in sequence with the first value in step 608, the process gives a wrong direction indication (step 612). The wrong direction indication may be signaled or otherwise presented to the driver by visual indicator 414 or audio alarm 416 both of FIG. 4. Next, the process sets the last value equal to the current value (step 610).

If the process determines the last value is less than or equal to the current value in step 606, the process determines whether the wrap around condition from the first value is in sequence with the last value (step 614). If the wrap around condition from the first value is in sequence with the last value, the process gives a wrong direction indication (step 612). If the wrap around condition from the first value is not in sequence with the last value in step 614, the process sets the last value equal to the current value.

The values used in FIG. 6 are a repeating or reoccurring sequence where a specified sequence reoccurs. For example, FIG. 6 may use values such as 001, 002, 003, 001 . . . . The values used in FIG. 5 are an ordinal sequence that does not repeat. For example, FIG. 5 may use numbers corresponding to State mile markers for the department of transportation such as . . . , 110, 111, 112, 113, . . . .

Thus, the illustrative embodiments provide a computer implemented method, apparatus, and computer usable program code for indicating whether vehicle is traveling in the proper direction. One or more radio frequency identification tags embedded in the roadway are read by a radio frequency identification tag reader on a vehicle as the vehicle traverses the radio frequency identification tags. The radio frequency identification tags include an associated value to indicate whether the vehicle is traveling in the correct direction. Any type of ordinal sequential arrangement may be used. If the vehicle is traveling contrary to an indicated direction of travel, such as opposing traffic of a freeway or in the wrong lane of a highway, the driver and/or other devices and individuals are alerted.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for determining a proper direction of travel of a vehicle, the computer implemented method comprising:
receiving a first value from a first radio frequency identification tag by the vehicle;
receiving a second value from a second radio frequency identification tag by the vehicle;
identifying a first value associated with the first radio frequency identification tag and a second value associated with the second radio frequency identification tag;
determining whether the second value is in an ordinal sequence with the first value to denote the proper direction of travel; and
responsive to a determination that the second value is not in ordinal sequence with the first value, signaling that the direction of travel of the vehicle is contrary to the proper direction of travel.

2. The computer implemented method of claim 1, wherein the vehicle is any of a car, truck, bus, train, bicycle, motorcycle, boat, or plane on a ground surface, and wherein the vehicle is equipped with a radio frequency identification tag reader.

3. The computer implemented method of claim 1, further comprising:
reading the first radio frequency identification tag;
reading the second radio frequency identification tag;
comparing read times for the first radio frequency identification tag and the second radio frequency identification tag; and
timing out if the read times do not occur within a specified interval of time.

4. The computer implemented method of claim 1, wherein the first value and the second value is a number, wherein the ordinal sequence is stored in a known bit position within the first radio frequency identification tag and the second radio frequency identification tag.

5. The computer implemented method of claim 1, wherein the ordinal sequence comprises incremental or decreasing values.

6. The computer implemented method of claim 1, wherein the ordinal sequence is a repeating ordinal sequence.

7. The computer implemented method of claim 1, wherein the first value and the second value are time-stamped when read and are stored in a memory.

8. The computer implemented method of claim 1, wherein the receiving, identifying, determining, and signaling steps are performed continuously while the vehicle is in motion.

9. The computer implemented method of claim 1, wherein the signaling step further comprises:
signaling the driver with an alert indicator.

10. The computer implemented method of claim 9, wherein the alert indicator is any of an audio, visual, or tactile alert.

11. The computer implemented method of claim 1, wherein the ordinal sequence is any of non-repeating ordinal sequence and a reoccurring sequence within a set of radio frequency identification tags.

12. The computer implemented method of claim 1, wherein the first radio frequency identification tag and the second radio frequency identification tag are activated by any of vehicle pressure, motion, sound or proximity of a radio frequency identification tag reader.

13. The computer implemented method of claim 1, wherein the reading, identifying, determining, and signaling steps are performed by the data processing system of the vehicle.

14. A direction indication system comprising:
a roadway including a set of radio frequency identification tags including at least a first tag and a second tag;
a vehicle including a computing platform wherein the computing platform further comprises:
a radio frequency identification tag reader for reading information from the set of radio frequency identification tags including a first value associated with the first tag and a second value associated with the second tag;
a computing system controlling functionality of the vehicle for processing the first value and the second value to determine a direction of travel; and
an alert system for alerting a driver that the direction of travel of the vehicle is contrary to a proper direction of travel.

15. The system of claim 14, wherein the vehicle further comprises:
a communication system for communicating with individuals and devices to alert the individuals and devices when the driver is traveling contrary to the proper direction of travel.

16. The system of claim 14, wherein the first radio frequency identification tag and the second radio frequency identification tag are embedded in the roadway and store information.

17. The system of claim 14, wherein the set of radio frequency identification tags are part of any of lane indicators, paint, speed bumps, guard rails, curbs, and reflector poles.

18. The system of claim 14, wherein the computing platform includes a global positioning system for displaying and receiving information from a user.

19. A computer program product comprising a computer usable medium including computer usable program code for determining a proper direction of travel of a vehicle, the computer program product comprising:
computer usable program code for receiving a first value from a first radio frequency identification tag by the vehicle;
computer usable program code for receiving a second value from a second radio frequency identification tag by the vehicle;
computer usable program code for identifying a first value associated with the first radio frequency identification tag and a second value associated with the second radio frequency identification tag;
computer usable program code for determining whether the second value is in an ordinal sequence with the first value to denote the proper direction of travel; and
computer usable program code responsive to a determination that the second value is not in sequence with the first value, for signaling that the direction of travel of the vehicle is contrary to the proper direction of travel.

20. The computer program product of claim 19, comprising computer usable program code for determining whether the second radio frequency identification tag was read within a specified time of the first radio frequency identification tag for determining whether a timeout has occurred.
